(19) United States
(12) Patent Application Publication
(10) Pub. No.: US 2026/0111098 A1
(43) Pub. Date: Apr. 23, 2026

(54) INTENT RESOLUTION ACROSS HIERARCHICAL USER PROFILES

(71) Applicant: GOOGLE LLC, Mountain View, CA (US)

(72) Inventors: Sarup Jagdish DALWANI, Bengaluru, Karnataka (IN); Martijn Franciscus Agnes COENEN, Eidenhoven (NL); Patrick Lee BAUMANN, San Jose, CA (US); Saumya PATHAK, London (GB); Smitha NAIK, Bengaluru, Karnataka (IN); Kedar Satish CHITNIS, Bengaluru, Karnataka (IN)

(21) Appl. No.: 19/118,107

(22) PCT Filed: Oct. 2, 2023
(86) PCT No.: PCT/US2023/075743

§ 371 Date: Apr. 3, 2025

Related U.S. Application Data
(60) Provisional application No. 63/413,480, filed on Oct. 5, 2022.

(51) Int. Cl. G06F 3/0482; G06F 3/0484; G06F 3/0488

(52) U.S. Cl. CPC G06F 3/0482; G06F 3/0484; G06F 3/0488

(57) ABSTRACT

A device, method and article of manufacture related to a mechanism for cross profile intent resolution is disclosed. An example method includes, in response to detecting a first user input associated with a first user profile stored on the computing device, generating a first intent that corresponds to the first user input, applying a sequence of cross profile intent filters to traverse a user profile hierarchy from the first user profile to a second user profile stored on the computing device, wherein the traversal of the user profile hierarchy is based on a successful resolution of each cross profile intent filter of the sequence of cross profile intent filters, identifying an application associated with the second user profile and configured to satisfy the first intent, and providing functionality from the application to satisfy the first intent via the first user profile.

### CROSS-REFERENCE TO RELATED APPLICATION

This application claims priority to U.S. Provisional Application No. 63/413,480, filed Oct. 5, 2022, which is incorporated by reference herein in its entirety.

### BACKGROUND

Computing devices such as mobile phones, laptops, and tablets implement operating systems that allow for the creation of user profiles which provide users with a means to segregate information and applications. For example, a user may establish one or more additional user profiles arranged in a parent-child relationship relative to the user. A user profile may be defined and configured for a specific purpose such as, for example, a work profile, or a kids profile. Applications within a user profile may utilize a messaging object available within the operating system known as an intent to request an action from one or more applications available within the user profile.

### SUMMARY

Operating systems that support multiple user profiles are often in need of a mechanism that allows for intent resolution between each of the different user profiles. In one example mechanism for cross profile intent resolution, when an intent request is received, the intent will initially be resolved in the current user profile. Subsequently, once the intent request has been resolved locally, the intent resolution mechanism of the present disclosure performs graph traversal starting from the current user profile and resolves the intent in each of the linked profiles (parent and children) along the path. The invoked user profiles can in turn resolve themselves and propagate the intent to each of the linked user profiles in turn, thereby resolving directly linked user profiles as well as user profiles that are linked through multiple intervening user profiles. Access to the user profiles may be determined by the configuration of the cross profile intent filters relative to each intent request. Accordingly, for different intent requests access to different paths or subsets of the graph may be dynamically allowed or denied based on the cross profile intent filters. Similarly, the same intent request from two different user profiles may likewise access different paths or subsets of the graph dynamically based on the cross profile intent filters

Implementation of cross profile intent filters maintains security by preventing unintended reconfiguration of intent filters by adding intent filters, removing filters, and/or otherwise changing intent filter permissions. Additionally, the implementation of cross profile intent filters does not alter or expand access or permissions to the user profiles which may expose the operating system to malicious agents and allow undesired access to one or more of the user profiles.

In one example, a computing device including at least one processor, and a computer readable storage device coupled to the at least one processor and having instructions stored is disclosed. The instructions, when executed by the at least one processor, causes the at least one processor to perform operations in response to detecting a first user input associated with a first user profile stored on the computing device. The computing device further includes instructions for generating a first intent that corresponds to the first user input, and applying a sequence of cross profile intent filters to traverse a user profile hierarchy from the first user profile to a second user profile stored on the computing device, wherein the traversal of the user profile hierarchy is based on a successful resolution of each cross profile intent filter of the sequence of cross profile intent filters. The executed instructions result in the computing device identifying an application associated with the second user profile and configured to satisfy the first intent, and providing functionality from the application to satisfy the first intent via the first user profile.

In another example, a computer implemented method is disclosed. The method includes in response to detecting a first user input associated with a first user profile stored on the computing device, generating a first intent that corresponds to the first user input, and then applying a sequence of cross profile intent filters to traverse a user profile hierarchy from the first user profile to a second user profile stored on the computing device wherein the traversal of the user profile hierarchy is based on a successful resolution of each cross profile intent filters of the sequence of cross profile intent filters. The method further includes identifying an application associated with the second user profile and configured to satisfy the first intent, and providing functionality from the application to satisfy the first intent via the first user profile.

In another example, a computer readable medium having stored therein instructions executable by a processor is disclosed. The computer readable medium includes instructions executable by the processor to generate, in response to detecting a first user input associated with a first user profile stored on a computing device, a first intent that corresponds to the first user input, apply a sequence of cross profile intent filters to traverse a user profile hierarchy from the first user profile to a second user profile stored on the computing device, wherein the traversal of the user profile hierarchy is based on a successful resolution of each cross profile intent filter of the sequence of cross profile intent filters. The computer readable medium further includes instructions to identify an application associated with the second user profile and configured to satisfy the first intent, and provide functionality from the application to satisfy the first intent via the first user profile.

In another example, a system for intent resolution is disclosed. The system includes a computing device that comprises means for generating, in response to detecting a first user input associated with a first user profile stored on the computing device, a first intent that corresponds to the first user input. The computing device further includes means for applying a sequence of cross profile intent filters to traverse a user profile hierarchy from the first user profile to a second user profile stored on the computing device wherein the traversal of the user profile hierarchy is based on a successful resolution of each cross profile intent filter of the sequence of cross profile intent filters, means for identifying an application associated with the second user profile and configured to satisfy the first intent, and means for providing functionality from the application to satisfy the first intent via the first user profile.

The foregoing summary is illustrative only and is not intended to be in any way limiting. In addition to the illustrative aspects, examples, and features described above, further aspects, examples, and features will become apparent by reference to the figures and the following detailed description and the accompanying drawings.

### BRIEF DESCRIPTION OF THE FIGURES

FIG. 1 illustrates intent resolution between two user profiles.

FIG. 2 illustrates intent resolution between multiple user profiles.

FIG. 3 illustrates an example of intent resolution across multiple user profiles arranged in a hierarchical relationship.

FIGS. 4A and 4B illustrate examples of intent resolution paths in accordance with the present disclosure.

FIG. 5 is an example computing device configured to implement a mechanism for intent resolution mechanism between multiple user profiles.

FIG. 6 is a block diagram of an example computing device, in accordance with the present disclosure.

FIG. 7 is a flowchart of a method of intent resolution between multiple user profiles, in accordance with the present disclosure.

FIG. 8 is a flowchart of another method of intent resolution between multiple user profiles, in accordance with the present disclosure.

### DETAILED DESCRIPTION

### Overview

In a number of operating systems implemented as part of a computing device, an intent is a messaging object configurable to specify, call and/or request an action from another application. Actions specified as part of an intent may include starting an activity such as opening a screen in an application, and starting a service such as downloading a file. Actions can further specify delivering a broadcast or message that includes data to be acted upon by one or more other applications. The intent may be defined either specifically or generally to identify the application or application component associated with one of the specified activities such as a start action, a receive action, and a broadcast action.

In one example, once an intent has been defined, the operating system searches the accessible applications and application components to activate by comparing the contents defined as part of the intent to one or more intent filters associated with application and application components available on the computing device. The intent filters associated with an application or application component may be specified in the metadata or manifest created for each application or application component. The comparison process is referred to as intent resolution. If the intent matches an intent filter, the operating system starts that application component and delivers the intent object to the application component. If the intent is found to satisfy multiple intent filters, the operating system may display a dialog that allows the user to select from the identified applications and application components. Intent resolution provides security and isolation between applications and application components. Maintaining isolation and security often results in limiting intent resolutions to a single user profile.

While an intent may often be resolved within the context of a single user profile, current operating systems are designed to support multiple user profiles. Accordingly, providing a mechanism to address intent resolution across multiple user profiles defined within an operating system to address different use cases while maintaining the security and isolation between applications, application components, and the individual user profiles represents a significant technological improvement. To address the additional requirements, in one example, an intent resolution mechanism arranges user profiles into a hierarchical format utilizing cross profile intent filters to provide dynamic access between the individual user profiles. For example, having multiple user profiles, a primary user profile may include one or more additional user profiles arranged in a parent-child relationship relative to the primary user profile.

In some examples, a computing device and operating system configured to implement multiple user profiles may organize two or more individual user profiles into a hierarchical relationship where different user profiles are isolated and secured but can be accessible via cross profile intent filters established between each profile or groups of profiles. For example, a user may establish a primary profile on a computing device such as a mobile phone and then define multiple additional user profiles to address specific use cases. The user may further define additional user profiles to address use cases such as segregating applications based on age, providing a secure transaction or financial space, and implementing multiple instances of a single application. In some examples, an intent generated at any one of the user profiles is resolved first within that user profile. Upon completion of the local intent resolution, the intent traverses a path defined by a user profile hierarchy and accessible through a sequence of cross profile intent filters. For example, the intent is resolved at each linked user profile based on the resolution of at least one of the sequence of cross profile intent filters configured along the traversed path. In practice, the linked user profiles individually resolve themselves, and then the intent continues to traverse the path defined by the user profile hierarchy until no further linked user profile remains or the resolution of at least one of the sequence of cross profile intent filters fails and access to the user profile is denied. The overall path and complexity of the user profile hierarchy required to completely resolve any given intent can change dynamically based on the resolution of the individual cross profile intent filters established between the user profiles or groups of user profiles defined within the user profile hierarchy. In this way, the cross profile intent filters control which paths, and between which individual user profiles and groups of user profiles, are traversed within any given portion of the user profile hierarchy. This mechanism results in an optimization of the intent resolution path defined as a part of the user profile hierarchy for each detected intent.

In some examples, any change to the configuration of multiple user profiles provided by the computing device and operating system can be dynamically detected during the traversal of the user profile hierarchy.

In some examples, the cross profile intent filters can be configured to prevent intent resolution across profiles when a local resolution is detected.

In some examples, the cross profile intent filters can be configured to assign a higher priority to an invoked user profile relative to the current user profile.

In some examples, the cross profile intent filters can be configured to prevent intent resolution unless the intent originated from a user profile having a higher priority relative to the current user profile.

### Mechanisms for Intent Resolution

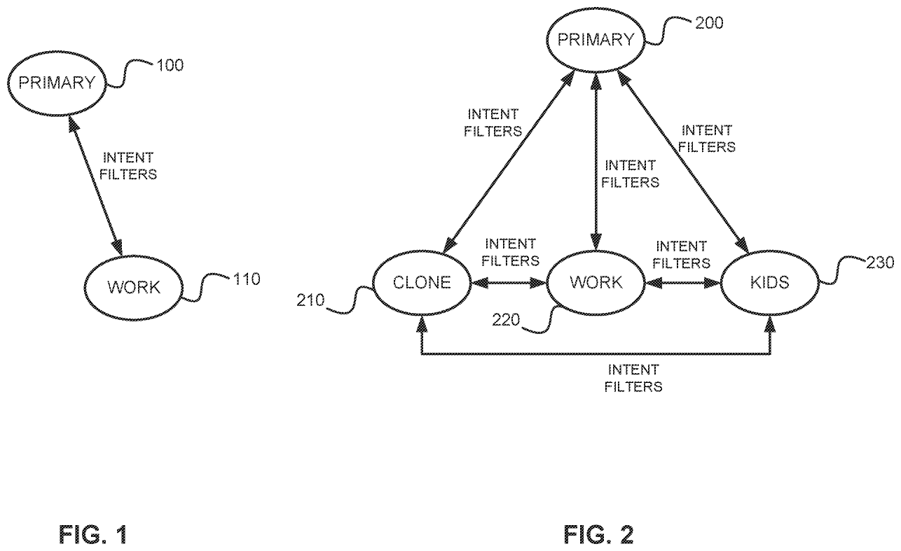

FIG. 1 illustrates intent resolution between two user profiles configured within an operating system of a computing device. For example, as depicted in FIG. 1, the resolution of an intent request between a first user profile 100 and a second user profile 110 may be accomplished by configuring individual intent filters between the two profiles. An intent generated in the first user profile 100 may include information such as an application or application component name to call, an action to be accomplished, data associated with the action, and category identifying the type of application or application component that may satisfy the intent. An intent filter specifies the type of intents that the second user profile 110 is configured to receive and/or accept. Individual intent filters are then configured for both the first user profile 100 and the second user profile 110 to control how intents communicated between the user profiles are handled.

In some examples, the intent filter configuration is directional between the two profiles such that the first profile 100 may be allowed to share information with the second profile 110 but the second profile 110 may not be allowed similar access. For example, if the first profile 100 is configured as a primary profile and the second profile 110 is configured as a work profile, then an intent filter configured between the two profiles may be defined to allow files to be shared from the primary profile to the work profile but files originating within the work profile may not be similarly shared outside the work profile.

The mechanism for intent resolution illustrated in FIG. 1 provides a simple solution that allows an intent request made in one user profile to be resolved in another directly connected user profile via one or more intent filters. The intent filters in the illustrated solution may be deployed and managed in a dynamic manner allowing for the addition, deletion, and modification of individual intent filters to be rapidly accomplished. In some cases, the illustrated mechanism for intent resolution may not support resolutions between user profiles arranged in nested relationships such as parent-child relationship, or other hierarchical relationships.

FIG. 2 illustrates another method for intent resolution which expands upon the method and resolution mechanism illustrated and discussed in FIG. 1. In particular, the second example method for intent resolution depicted in FIG. 2 provides a mechanism for directly addressing intent resolution across multiple user profiles. The second example of a mechanism for intent resolution includes a first user profile 200, a second user profile 210, a third user profile 220, and a fourth user profile 230 each arranged in direct communication with each of the other profiles via intent filters configured individually between each pair of user profiles.

In the example configuration illustrated in FIG. 2, individual intent filters may be configured between each of the pairs of user profiles. Thus, each user profile configured according to the second example for intent resolution is in direct communication with each of the other user profiles organized in this manner by way of dedicated intent filters configured specifically for each user profile. For example, the first user profile 200 may be configured as a primary profile, the second user profile 210 may be configured as a clone profile of the primary profile, the third user profile 220 may be configured as a work profile, and the fourth user profile 230 may be configured as an age-dependent kids profile. Between each of these user profiles intent filters may be configured to define how each profile interacts with the other profiles. For example, the kids profile may be individually configured to interact with the work profile, the clone profile and the primary profile. This configuration requires intent filters to be defined and maintained for each linked profile. Similarly, the clone and work profiles may each have individually configured intent filters established between each of the linked profiles.

The example intent resolution methodology illustrated in FIG. 2 provides a solution allowing intent calls made between multiple user profiles to be resolved in one or more directly connected user profiles via the network of intent filters defined between each of the individual user profiles. These intent filters are individually managed and deployed for each user profile and connection between user profiles. This intent resolution method is complex and may include a number of redundant intent filters but also allows for the flexibility to quickly modify individual intent filters for each user profile. The direct connections utilized by the illustrated methodology for intent resolution may not support intent resolution between user profiles arranged in nested relationships such as parent-child relationship, or other hierarchical relationships.

In order to address multiple user profiles in a hierarchical relationship, the illustrated solution may require that individual intent filters be configured between each user profile to which intent resolution is desired. Modification of the illustrated method including adding or removing user profiles results in a large number of related intent filters needing to be configured and/or maintained for each of the direct connections. For example, if there are N number of user profiles configured within an operating system of a computing device, then there are (N*(N-1))/2 lists of intent filters that must be configured to ensure that the intent resolution propagates to each connected user profile. Thus, while this second example for intent resolution may resolve an intent request originating in another user profile, this methodology often results in a complex and redundant network of intent filters that must be maintained and updated for any change to each of the linked user profiles. Additionally, while the web of direct connections between the user profiles may allow for intent resolution, this mechanism for intent resolution does not support efficient resolutions between user profiles arranged in nested relationships such as parent-child relationship, or other hierarchical relationships.

### Mechanism for Cross Profile Intent Resolution

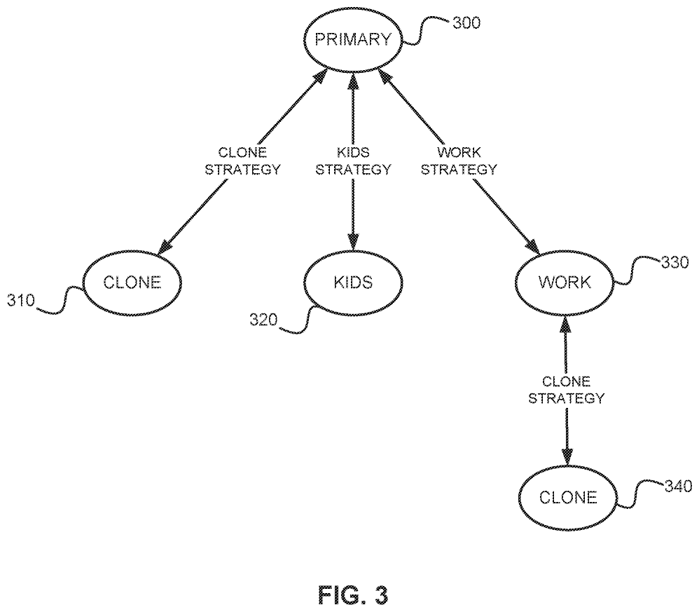

FIG. 3 illustrates a cross profile intent resolution mechanism that addresses and overcomes the limitation discussed in connection with the example mechanisms and methodologies illustrated in FIGS. 1 and 2. The example cross profile intent resolution mechanism as disclosed herein and depicted in FIG. 3 provides a uniform and scalable mechanism to dynamically resolve an intent across multiple user profiles arranged in nested relationships.

The example cross profile intent resolution mechanism as illustrated in FIG. 3 includes a first user profile 300 arranged in direct connection with each of a second user profile 310, a third user profile 320, and a fourth user profile 330. This direct communication between the first user profile 300 and the remaining user profiles 310-330 defines a parent-child relationship. Similarly, the fourth user profile 330 is further arranged in direct communication with a fifth user profile 340 forming another parent-child relationship. The illustrated arrangement of user profiles including the multiple parent-child relationships existing between the first user profile 300 and the fourth user profile 330, and the fourth user profile 330 and the fifth user profile 340 depicts a simple nested relationship between the user profiles. The example cross profile intent resolution mechanism provides for an intent generated at one of the user profiles to be resolved at each of the linked user profiles without the need to establish direct communications for each user profile. Thus, the illustrated cross profile intent resolution mechanism of FIG. 3 can resolve an intent when user profiles are isolated and configured in a nested arrangement. It will be understood that configurations of greater complexity may be implemented without departing from the principles disclosed herein.

In the example cross profile intent resolution mechanism illustrated in FIG. 3, the intent filters currently utilized and configured between each individual user profile to control access to another user profile have been replaced as shown. The replacement of the individual intent filters with a cross profile intent resolution mechanism as disclosed reduces the configuration and maintenance complexity incurred using individual intent filters defined between each user profile. Moreover, the replacement of individual intent filters with the disclosed cross profile intent resolution mechanism simplifies the process of adding and modifying user profiles. The replacement of individual intent filters with the disclosed cross profile intent resolution mechanism reduces the security concerns arising from each individual user profile being in communication with each other user profile in order to facilitate cross profile communication. For example, by removing the need for direct communication between each user profile, the disclosed cross profile intent resolution mechanism prevents the malicious addition of new intent filters and/or the modification of existing intent filters to provide unauthorized access. The example cross profile intent resolution mechanism replaces the individually configured intent filters defined for each of the user profiles with one or more cross profile intent filters operating in conjunction with a cross profile strategy.

In some examples, the first user profile 300 may be configured as a primary profile, the second user profile 310 may be configured as a clone profile of the primary profile, the third user profile 320 may be configured as a kids profile, and the fourth user profile 330 may configured as a work profile and further include the fifth user profile 340 configured as a clone profile of the work profile. The fourth user profile 340 and the fifth user profile 350 as provided by the cross profile intent resolution mechanism allows the two profiles to be organized in a parent-child relationship. In this relationship, the clone profile may be organized with the work profile to allow seamless integration or communication between the two user profiles. In other examples, this relationship allows an intent originating a user profile to be communicated to the parent user profile and be resolved seamlessly by both the parent and child user profiles.

In the illustrated example, access between each of these user profiles may be controlled by dedicated cross profile strategies operating in connection with one or more cross profile intent filters. For example, the disclosed cross profile intent resolution mechanism allows the flexibility for each of the user profiles 300-340 to resolve an intent according to one or more cross profile intent filters and a cross profile strategy that may be configured to address a desired use case associated with the user profile. In a use case where second user profile 310 is a clone profile of the primary profile 300, the cross profile strategy may ensure seamless communication between the two user profiles such that intent resolution is accomplished in the same manner for both the first user profile 300 and the second user profile 310. In another use case where the third user profile is a kids profile associated with the first user profile 300, the cross profile strategy may be configured to limit access to age prohibited applications and application components. For example, the cross profile strategy may identify that certain applications may be designated as age restricted or may be configured to identify certain applications or actions as age restricted. In another use case where the fourth user profile 330 is a work profile associated with first user profile 300, the cross profile strategy between the primary profile and the work profile may be configured by a third party administrator to control and/or limit access to work applications and work application components. The fifth user profile 340 may be configured as a clone profile of the fourth user profile 330, and as with the cross profile strategy between the first user profile 300 and the second user profile 310, the cross profile strategy between the work profile and the clone of the work profile may ensure seamless communication between the two user profiles. In one example, the fourth user profile 330 and the fifth user profile 340 are organized into a parent-child relationship and may be configured to implement different strategies such as: resolve an intent in both profiles (2) resolve an intent current profile and skip neighbor profile (3) skip current profile and resolve an intent in neighbor profile (4) resolve in neighbor only if there are no application is identified in the current profile. In some examples, the cross profile strategy may be a duplicate strategy for each of the clone profiles associated with the second user profile 310 and the fifth user profile 340. In further examples, the cross profile strategy for a clone profile may be stored in a first location and referenced by each user profile configured and identified as a clone profile.

In some examples, when an intent request originates within any user profile implemented according to the disclosed cross profile intent resolution mechanism, the intent is initially resolved within the current user profile. Upon completion of the intent resolution within the current (i.e., local) user profile, the intent is communicated to any other linked user profile as dictated by the nested relationship between current user profile and any other linked user profile. Communication between each of the linked user profiles is facilitated by the cross profile intent filters operating in connection with a cross profile strategy. For example, access to, and the subsequent intent resolution within, each user profile linked to the current user profile depends upon the successful resolution of at least one of the cross profile intent filters and the routing or direction of the intent request according to the cross profile strategy. For example, upon successful resolution of a path between two user profiles, the appropriate cross profile strategy may direct the intent request to skip to the next profile. However, if the intent is not resolved by one of the cross profile intent filters, then no path for communication is allowed between the two linked user profiles and the graph traversal along this path ends without including any nested relationships linked to the unresolved portion of the graph. In this way the resolution of the cross profile intent filters provides a dynamic mechanism to evaluate and access each of the linked user profiles arranged in a hierarchical relationship. In operation, two intent requests originating within the same user profile in a hierarchy may resolve, depending upon their interactions with one or more cross profile intent filters and cross profile strategies, along two different paths between multiple linked user profiles within the hierarchy.

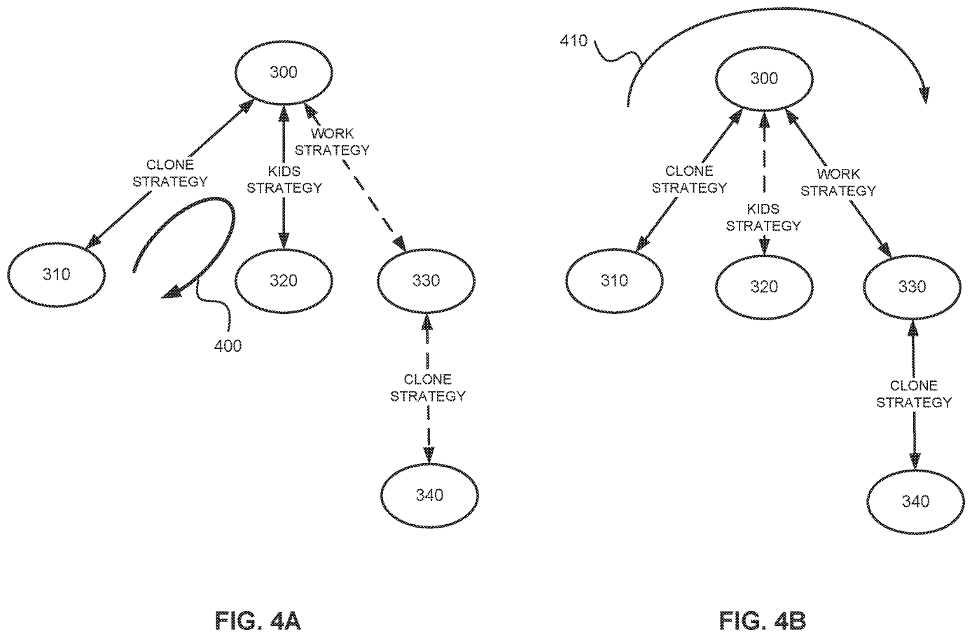

FIGS. 4A and 4B illustrate possible paths that may be traversed with an example user profile hierarchy in response to an intent request and resolved via the example cross profile intent resolution mechanism shown in FIG. 3. FIG. 4A illustrates a first path 400 along which an intent request originating within the second user profile 310 may be resolved. Upon resolution in the second user profile 310, the intent traverses to the first user profile 300 for further resolution. The intent may pass seamlessly between the second user profile 310 and the first user profile 300 because the second user profile 310 is configured as a clone of the first user profile 300. At this point, the intent request may not be resolved by one of the cross profile intent filters between the first user profile 300 and the fourth user profile 340, or the cross profile strategy may disallow access to the fourth user profile 340 thereby preventing access to the related portions of the user profile hierarchy. For example the cross profile intent filters and the cross profile strategy could prevent access between the primary profile and the work profile based on the previous resolution of the intent request at the primary profile. FIG. 4B illustrates a second path 410 along which a second intent detected within the second user profile 310 may be resolved. As described above, the intent may pass seamlessly between the second user profile 310 and the first user profile 300 because the second user profile 310 is configured as a clone of the first user profile 300. Upon resolution in the second user profile 310, the intent traverses to the first user profile 300 for further resolution. At this point, the intent request may fail to resolve at the cross profile intent filters established between the first user profile 300 and the third user profile 320 which, in turn, prevents access to third user profile 320 configured as kids profile. The failure to resolve the intent request at the cross profile intent filters established between the first user profile 300 and the third user profile 320 results in no path existing between the two profiles and no intent resolution occurring at the third user profile 330 and any other profile in a nested relationship with the third user profile 330. Accordingly, the graph traversal for any given intent may be different from the graph traversal for another intent based on the interaction with the cross profile intent filters and cross profile strategies implemented to secure and isolate the multiple user profiles. Moreover, the paths for graph traversal may update in real time based on the configuration and arrangement of the multiple user profiles. Advantageously, the cross profile intent filters related to one of the user profiles may be updated without affecting the other linked user profiles and related cross profile intent filters. Similarly, the cross profile strategies related between pairs of user profiles may be updated without affecting the cross profile filters the other linked user profiles and related cross profile intent filters. For example, one or more cross profile strategies may be configured to assign a higher priority to one of the other user profiles relative to the current user profile, or in some cases cross profile intent resolution may be reserved for activity or actions identified as high priority, and/or activity from user profiles identified as high priority user profiles. In this way, the cross profile strategies may assign priorities to establish an order between the user profiles, and to create a directional filter between high and low priority user profiles, and to filter activities between user profiles of different priorities.

### Mechanism for Cross Profile Intent Resolution

A computing device including hardware and software elements for implementing a cross profile intent resolution mechanism between multiple user profiles arranged in a hierarchical relationship is disclosed and described.

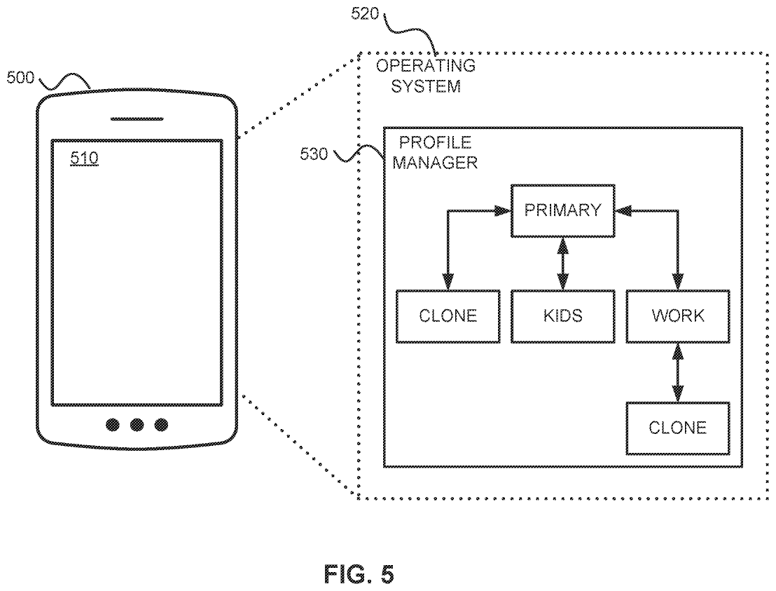

FIG. 5 illustrates an example computing device 500 for implementing the disclosed mechanism for intent resolution across multiple user profiles, in accordance with one or more examples. The computing device 500 may include a touchscreen display 510 configured to display information and receive one or more provided inputs from a user interacting with the device. In some examples, the computing device 500 may be a laptop, a desktop computer, a smart television, an electronic reading device, a streaming content device, a gaming console, a tablet device, or other related computing devices that are configured to execute software instructions and application programs. The computing device 500 may include an operating system 520 that includes a disclosed mechanism for intent resolution across multiple user profiles. In some examples, the operating system 520 may execute a profile manager application 530. The profile manager 530 may provide the interface and tools needed to configure one or more user profiles such as the user profiles 300-340 discussed in connection with FIG. 3. The profile manager 530 may further provide the tools to organize and arrange the user profiles in a hierarchical arrangement such that each pair of user profiles forms a parent-child relationship.

The terms application and application component as used herein, can be any computer program or functionality accessible by the operating system and configured to interact with a user of computing device 500. Example applications can include a search application, an email application, a text message application, an instant messaging application, a web browsing application, a mapping application, a media playback application, a weather application, a phone application, a video communication application, a camera application, an application associated with a service provider (e.g., financial, insurance, etc.), an application associated with a digital assistant (e.g., a home assistant), or any other application configured to receive user input such as digital text input, alpha-numeric input, character input, and/or digital image input.

The terms interaction or interact are broadly used to refer to any action, active or passive, performed by a user with computing device 500, or performed by an application or application component executing on the computing device 500. For example, an interaction can involve viewing content, inputting, editing, and/or modifying content (e.g., via a keyboard, a mouse, a tap, and so forth), a sensory interaction (e.g., haptic, visual, auditory, tactile, and so forth), a scrolling interaction, a voice interaction, a user selection, and so forth. As another example, a user interaction with an electronic mail can be determined to be an interaction with an entire chain of electronic mails, and/or a plurality of mail exchanges with a particular sender of the electronic mail.

### Computing Device Architecture

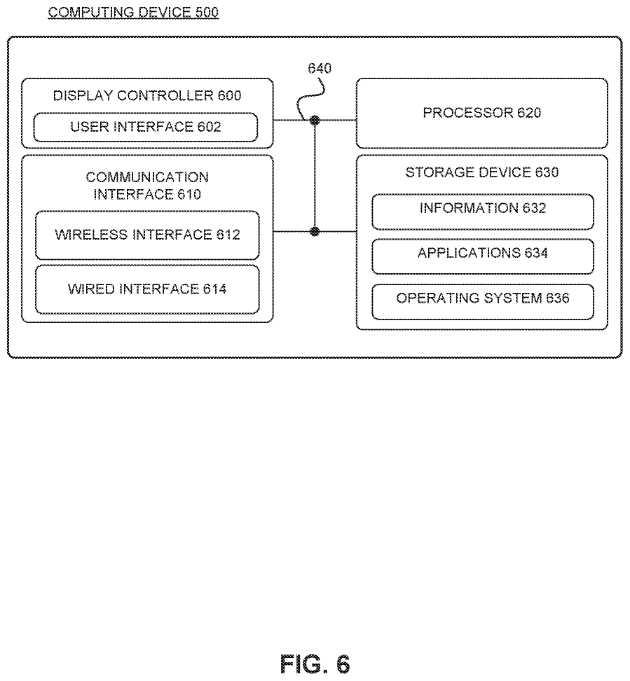

FIG. 6 is a functional illustration of one example of a hardware configuration that may be implemented as part of the computing device 500 illustrated in FIG. 5. In some examples, the configuration of the computing device 500 shown in FIG. 6 supports the definition of multiple user profiles, and the definition of relationships and hierarchies between the multiple relationships including a mechanism for cross profile intent resolution as described herein. The example computing device 500 may include at least a display controller 600, a communication interface 610, a processor 620, and a storage device 630, all of which may be in communication with each other via a system bus, network, or other connection mechanism 640.

The display controller 600 may be configured to control the touchscreen display 510 and generate a user interface 602 configured to receive an input provided by a user. For example, the touch screen display 510 can be configured to receive information from a user input, and can receive the input via a peripheral device such as, a computer mouse, a keyboard, a keypad, a touch pad, a trackball, a joystick, and other similar devices. The touch screen display 510 can further be configured to display the generated graphical user interface 602 including data 632, and one or more applications 634 saved within the storage device 630. The touch screen display 510 may be a liquid crystal display (LCDs), light emitting diodes (LEDs), and other similar devices.

The communication interface 610 may include one or more devices that provide a wireless interface 612 and a wired interface 614 that are configurable to allow the computing device 500 to communicate via a network. The wireless interface 612 can include any hardware and software necessary for wireless communication such as, for example, a wireless transmitter, a receiver, and/or a transceiver such as a Bluetooth™ transceiver or any other wireless transceiver configurable to communicate via a wireless network. The wired interface 614 can include any hardware and software necessary for wired communication such as, for example a transmitter, a receiver, and/or a transceiver such as an Ethernet transceiver or any other similar transceiver configurable to communicate via a wired network.

The processor 620 may be a multi-core processor, a general purpose processor, and/or a special purpose processor such as a graphics processing unit (GPU). The processor 620 may be configured to execute the operating system 636, data 632, and one or more application 634 saved within the storage device 630.

The storage device 630 may be configured to store the operating system 636, data 632, and one or more applications 634 in a computer readable storage media including both volatile and non-volatile storage components such as optical discs, magnetic tape, or other storage technology that can be integrated in whole or in part with the processor 620. The storage device 630 may include computer readable instructions and data as needed to ensure the operation of the computing device 500.

### Example Methods of Operation

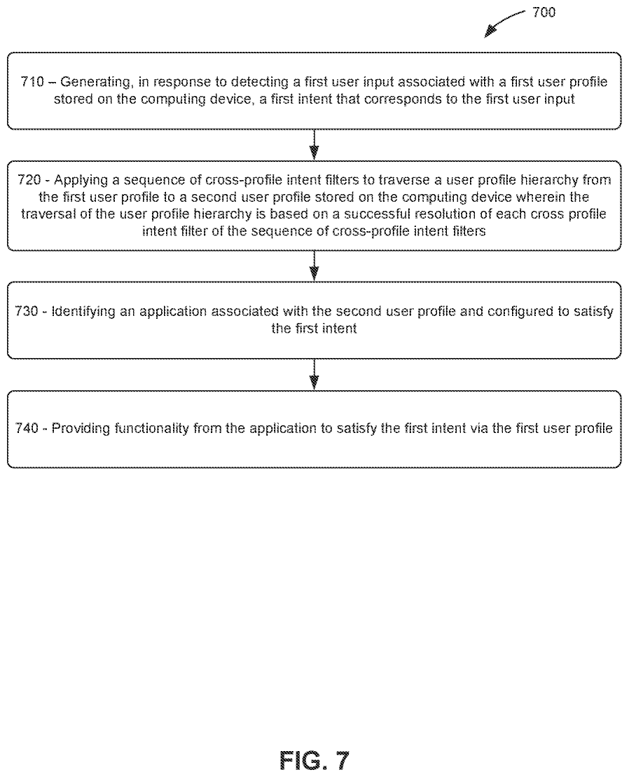

FIG. 7 is a flowchart 700 of an example method of implementing a mechanism for cross profile intent resolution in accordance with one or more of the examples disclosed.

The example method for cross profile intent resolution as described in flowchart 700 may be implemented according to coded logic stored in the storage device 630 and executed by the processor 620. In some examples, the results of this method may be presented in the user interface 602 portion of the computing device 500. The boxes of the flowchart correspond to individual steps and/or elements of one example method for cross profile intent resolution.

At block 710, the method shown in flowchart 700 begins with, in response to detecting a first user input associated with a first user profile stored on the computing device, generating a first intent that corresponds to the first user input.

At block 720, the method continues by applying a sequence of cross profile intent filters to traverse a user profile hierarchy from the first user profile to a second user profile stored on the computing device, wherein the traversal of the user profile hierarchy is based on a successful resolution of each cross profile intent filter of the sequence of cross profile intent filters.

At block 730, the method continues by identifying an application associated with the second user profile and configured to satisfy the first intent.

At block 740, the method continues by providing functionality from the application to satisfy the first intent via the first user profile.

In some examples, the method includes displaying a user interface via a touchscreen display coupled to the processor and the storage device.

In some examples, the method includes receiving the first user input via the touchscreen display.

In some examples, the method includes displaying within the graphical user interface an element corresponding to a first action associated with the first intent.

In some examples, the method includes selecting the first action from the group consisting of: a start action; a receive action; and a broadcast action.

In some examples, the application is associated with a first intent filter defined for each of a plurality of applications associated with the second user profile

In some examples, the first filter is a manifest associated with each of a first plurality of applications.

In some examples, the sequence of cross profile intent filters is selected from the group consisting of: a priority filter; a directional filter; and an activity filter.

In some examples, the priority filter is configured to prevent low priority cross profile traffic.

In some examples, the method includes applying the sequence of cross profile intent filters to traverse the user profile hierarchy, the method further includes resolving user profiles in a parent-child relationship.

In some examples, the method includes the sequence of cross profile intent filters to traverse the user profile hierarchy the method further includes an iterative graph traversal.

In some examples, the method further includes a cross profile strategy associated with at least one of the sequence of cross profile intent filters, wherein the cross profile strategy is configured to control resolution with the second user profile based on a successful resolution of the first intent at the first user profile.

In some examples, the method includes identifying an application associated with the second user profile and configured to satisfy the first intent, and the method further includes resolving the first intent by comparing a first action to a first filter associated with each of a plurality of applications included within the second user profile.

In some examples, the method includes identifying an application associated with the second user profile and configured to satisfy the first intent, the method further includes providing a first list including the identified application configured to satisfy the first intent.

In some examples, the method includes providing functionality from the application to satisfy the first intent via the first user profile includes displaying the first list.

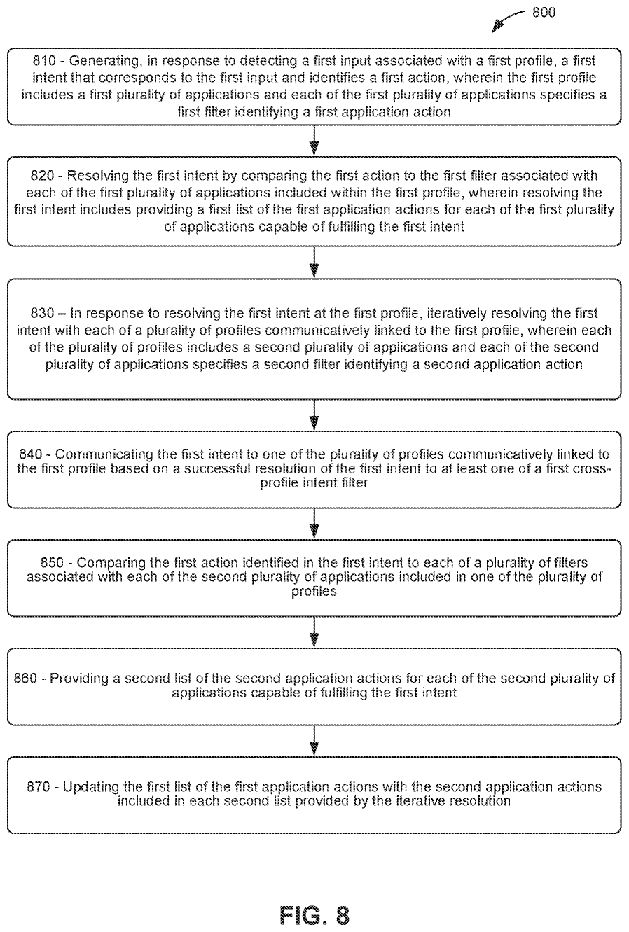

FIG. 8 is a flowchart 800 of another method of implementing a mechanism for cross profile intent resolution in accordance with one or more of the examples disclosed.

In one example method for cross profile intent resolution as described in flowchart 800 may be implemented according to coded logic stored in the storage device 630 and executed by the processor 620 of the computing device 500. The boxes of the flowchart correspond to individual steps and/or elements of one example of a method for cross profile intent resolution.

At block 810, the method shown in flowchart 800 begins by generating, in response to detecting a first input associated with a first profile, a first intent that corresponds to the first input and identifies a first action; wherein the first profile includes a first plurality of applications and each of the first plurality of applications specifies a first filter identifying a first application action.

At block 820, the method continues by resolving the first intent by comparing the first action to the first filter associated with each of the first plurality of applications included within the first profile, wherein resolving the first intent includes providing a first list of the first application actions for each of the first plurality of applications capable of fulfilling the first intent.

At block 830, the method continues by, in response to resolving the first intent at the first profile, iteratively resolving the first intent with each of a plurality of profiles communicatively linked to the first profile, wherein each of the plurality of profiles includes a second plurality of applications and each of second plurality of applications specifies a second filter identifying a second application action.

At block 840, the method continues by communicating the first intent to one of the plurality of profiles communicatively linked to the first profile based on a successful resolution of the first intent to at least one of a first cross profile intent filter.

At block 850, the method continues by comparing the first action identified in the first intent to each of a plurality of filters associated with each of the second plurality of applications included in one of the plurality of profiles.

At block 860, the method continues by providing a second list of the second application actions for each of the second plurality of applications capable of fulfilling the first intent.

At block 870, the method continues by updating the first list of the first application actions with the second application actions included in each second list provided by the iterative resolution.

In another example, a system for intent resolution is disclosed. The example system may be configured to implement one or more of the methods illustrated in FIGS. 7 and 8. One example system may include a computing device that comprises means for generating, in response to detecting a first user input associated with a first user profile stored on the computing device, a first intent that corresponds to the first user input. The means for generating may include the processor 620 and the storage device 630 responding to the user interface 602. The system may further include means for applying a sequence of cross profile intent filters to traverse a user profile hierarchy from the first user profile to a second user profile stored on the computing device wherein the traversal of the user profile hierarchy is based on a successful resolution of each cross profile intent filter of the sequence of cross profile intent filters, means for identifying an application associated with the second user profile and configured to satisfy the first intent, and providing functionality from the application to satisfy the first intent via the first user profile. Similarly, the means for applying and the means for identifying may include the processor 620 and the storage device 630 operating in conjunction to evaluate the applications 634 stored in the storage device 630. The means for providing functionality may in some examples include the user interface 602, a selection presented via the touchscreen 510 and/or the operating system 636.

The present disclosure is not to be limited in terms of the particular examples described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative examples described in the detailed description, figures, and claims are not meant to be limiting. Other examples and configurations can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with the disclosed examples. Alternative examples are included within the scope of the provided disclosure. In some examples, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

With respect to examples that include messaging, and communication of device information and any other user information stored on one of the example computing devices, the stored information may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is communicated, collected, or otherwise made available about the user, how that information is used, and what information is provided to the user.

While various aspects and examples have been described herein, other aspects and examples will be apparent to those skilled in the art. The various aspects and examples disclosed herein are provided for explanatory purposes and are not intended to be limiting, with the true scope being indicated by the following claims.

What is claimed is:

1. A computing device including at least one processor, and a computer readable storage device coupled to the at least one processor and having instructions stored thereon that, when executed by the at least one processor, causes the at least one processor to perform operations comprising:
in response to detecting a first user input associated with a first user profile stored on the computing device, generating a first intent that corresponds to the first user input;
applying a sequence of cross profile intent filters to traverse a user profile hierarchy from the first user profile to a second user profile stored on the computing device, wherein the traversal of the user profile hierarchy is based on a successful resolution of each cross profile intent filter of the sequence of cross profile intent filters;
identifying an application associated with the second user profile and configured to satisfy the first intent; and
providing functionality from the application to satisfy the first intent via the first user profile.

2. The computing device of claim 1 further including:
a touchscreen display coupled to the processor and the computer readable storage device, wherein the touchscreen display is configured to display a graphical user interface.

3. The computing device of claim 2, wherein the touchscreen display is configured to receive the first user input.

4. The computing device of claim 2, wherein the graphical user interface is configured to display an element corresponding to a first action associated with the first intent.

5. The computing device of claim 4, wherein the first action is selected from the group consisting of: a start action; a receive action; and a broadcast action.

6. The computing device of claim 1, wherein the application is associated with a first intent filter defined for each of a plurality of applications associated with the second user profile.

7. The computing device of claim 1, wherein the application includes a first intent filter that is a manifest associated with each of a first plurality of applications.

8. The computing device of claim 1, further comprising a cross profile strategy associated with at least one of the sequence of cross profile intent filters, wherein the cross profile strategy is configured to control resolution with the second user profile based on a successful resolution of the first intent at the first user profile.

9. The computing device of claim 1, wherein applying the sequence of cross profile intent filters to traverse the user profile hierarchy includes resolving user profiles in a parent-child relationship.

10. The computing device of claim 1, wherein applying the sequence of cross profile intent filters to traverse the user profile hierarchy includes an iterative graph traversal.

11. The computing device of claim 1, wherein identifying an application associated with the second user profile and configured to satisfy the first intent includes resolving the first intent by comparing a first action to a first filter associated with each of a plurality of applications included within the second user profile.

12. The computing device of claim 1, wherein identifying an application associated with the second user profile and configured to satisfy the first intent includes providing a first list including the identified application configured to satisfy the first intent.

13. The computing device of claim 12, wherein providing functionality from the application to satisfy the first intent via the first user profile includes displaying the first list.

14. A computer implemented method comprising:
in response to detecting a first user input associated with a first user profile stored on a computing device, generating a first intent that corresponds to the first user input;
applying a sequence of cross profile intent filters to traverse a user profile hierarchy from the first user profile to a second user profile stored on the computing device, wherein the traversal of the user profile hierarchy is based on a successful resolution of each cross profile intent filter of the sequence of cross profile intent filters;
identifying an application associated with the second user profile and configured to satisfy the first intent; and
providing functionality from the application to satisfy the first intent via the first user profile.

15. The computer implemented method of claim 14, wherein applying the sequence of cross profile intent filters to traverse the user profile hierarchy includes resolving user profiles in a parent-child relationship.

16. The computer implemented method of claim 14, wherein applying the sequence of cross profile intent filters to traverse the user profile hierarchy includes an iterative graph traversal.

17. The computer implemented method of claim 14, wherein identifying an application associated with the second user profile and configured to satisfy the first intent includes resolving the first intent by comparing a first action to a first filter associated with each of a plurality of applications included within the second profile.

18. The computer implemented method of claim 14, wherein identifying an application associated with the second user profile and configured to satisfy the first intent includes providing a first list of the identified application configured to satisfy the first intent.

19. An article of manufacture comprising at least one processor, and a computer readable storage device coupled to the at least one processor and having instructions stored thereon that, when executed by the at least one processor of a computing device, causes the computing device to carry out functions comprising:
in response to detecting a first user input associated with a first user profile stored on the computing device, generating a first intent that corresponds to the first user input;
applying a sequence of cross profile intent filters to traverse a user profile hierarchy from the first user profile to a second user profile stored on the computing device, wherein the traversal of the user profile hierarchy is based on a successful resolution of each of the cross profile intent filter of the sequence of cross profile intent filters;
identifying an application associated with the second user profile and configured to satisfy the first intent; and
providing functionality from the application to satisfy the first intent via the first user profile.
